(19) United States
(12) Patent Application Publication
(10) Pub. No.: US 2017/0229273 A1
(43) Pub. Date: Aug. 10, 2017

(54) ELECTRIC FUSE ARRANGEMENT WITH A METAL FOAM AND METHOD FOR INTERRUPTING AN ELECTRIC CURRENT USING THE FUSE ARRANGEMENT

(71) Applicant: SIEMENS AKTIENGESELLSCHAFT, MUN ICH (DE)

(72) Inventors: HOLGER SIEGMUND BREHM, ERLANGEN (DE); MATTHIAS BOEHM, NEUENDETTELSAU (DE); DANIEL SCHMITT, POSTBAUER-HENG (DE)

(21) Appl. No.: 15/501,928

(22) PCT Filed: Aug. 6, 2014
(86) PCT No.: PCT/EP2014/066939

§ 371 Date: Feb. 6, 2017

(51) Int. Cl. H01H 85/06; H01H 85/165; H01H 69/02; H01H 85/02

(52) U.S. Cl. CPC H01H 85/06; H01H 85/0241; H01H 85/165; H01H 69/02; H01H 2085/0283

(57) ABSTRACT

An electrical fuse configuration or arrangement includes two contact pieces which are placed on top of each other and between which a metal foam is located. A method for interrupting an electric current by using the electrical fuse configuration includes melting the metal foam at a current value exceeding a predetermined threshold or maximum current value.

The invention relates to an electric safety arrangement.

Safety arrangements are known from the prior art. They are used to interrupt an electrical contact in the event of a fault, for example in case of a short-circuit.

For example, DE 20 2012 000 571 U1 describes an electrical safety element with a fusible wire which interrupts an electrical connection in the event of a short-circuit.

The object of the invention is the proposal of a safety arrangement which is simple and reliable.

This object is fulfilled by a safety arrangement according to the invention, wherein a metal foam is located between two contact pieces arranged one on top of the other.

The metal foam incorporates internal pores, such that its volume is increased in relation to a solid metal material. This property can be exploited in order to effect the separation of electrical contact between the two contact pieces, where required, by a reduction in the volume of the metal foam. Such a requirement will occur, for example, if the safety arrangement according to the invention is subject to a comparatively high current load. In this case, for example, the metal foam can be caused to melt. Under normal conditions of current loading, as the metal foam shows comparatively good electrical conductivity, current can flow via the contact pieces and the metal foam.

A simple and reliable safety arrangement is thus provided.

The safety arrangement according to the invention has a further advantage, in that the porosity of the metal foam provides greater flexibility, in comparison with a solid material. As a result, the metal foam can act as a contact spring for the equalization, for example, of manufacturing-related dimensional tolerances.

As metal foams, for example, foams based upon steel, aluminum or titanium oxide are conceivable. The metal foam can be produced by the powder metallurgy method, which will be known to a person skilled in the art. By this method, a metal powder (for example aluminum powder) is mixed with a gas-splitting propellant (for example titanium hydride). The powder mixture is then compressed, and is foamed in a thermal treatment process. The production of metal foam by a hot-melt metallurgical method, which will also be known to a person skilled in the art, is also conceivable. Methods for the production of a metal foam are described, for example, in the printed publication DE 10 2006 031 213 B3. In the known methods, the number and size of the resulting pores in the metal foam, and thus the elastic properties of the metal foam, can be selected virtually at will. The elastic properties can thus be characterized, for example, by the modulus of elasticity. As the proportional volume of pores increases, the modulus of elasticity of the metal foam, and thus its rigidity, is reduced accordingly.

According to a preferred form of embodiment of the invention, the metal foam is configured as a—for example quadrilateral—metal foam body. The metal foam body is arranged between the two contact pieces such that, upon the melting thereof, electrical isolation is effected between the contact pieces. Electrical isolation can be achieved, for example, by means of an air gap between the contact pieces. The air gap between the contact pieces can be formed, for example, by a reduction in the volume of the metal foam body. This reduction in volume specifically occurs as a result of the melting of the metal foam body.

If the two contact pieces are arranged one above the other, the metal of the melting metal foam body, for example by the action of gravitational force, will be deposited in the direction of the contact piece which is arranged on the bottom, thus forming an air space or air gap between the contact pieces. This air gap can provide a sufficiently high electrical resistance for the interruption of electrical contact or for the electrical isolation of the contact pieces. In such a mutual spatial arrangement of the contact pieces, the action of another force, for example a magnetic force, upon the melting metal foam body is also conceivable.

Appropriately, the metal foam body is a constituent element of the contact pieces. This means that the metal foam body is integrally bonded to one of the contact pieces, and thus does not constitute an independent component. By this arrangement, the design of the safety arrangement can be further simplified. Specifically, in this connection, the metal foam body can appropriately assume a current-carrying function within the contact piece.

The metal foam body is preferably designed such that it will melt upon the passage of a current through the safety arrangement which exceeds a predefined threshold current value. In this case, the safety arrangement will be actuated, specifically in the event of a short-circuit. The flow of a short-circuit current in the safety arrangement is associated with high thermal losses. In turn, these result in an increase in temperature in the safety arrangement. The metal foam material of the metal foam body should appropriately be selected such that the melting temperature of the metal foam body corresponds to the threshold current value: the metal foam body will then melt in response to currents exceeding the threshold current value. In this way, electrical isolation of the contacts in case of a short-circuit current exceeding the threshold current value can be achieved.

By way of deviation, melting of the metal foam body can be achieved by another means, for example by the deliberate heating of the metal foam using a current-carrying heating element.

The safety arrangement according to the invention can be particularly advantageously deployed or employed in an electrical device having at least one semiconductor component between the contact elements which are arranged one on top of the other, wherein the semiconductor component is arranged to form an electrical series circuit with the metal foam body, and the series circuit can be separated by the melting of the metal foam body.

An appropriate electrical device for this purpose is known, for example, from printed document EP 1 403 923 A1. A semiconductor module is described therein, comprising a plurality of semiconductor chips arranged in parallel in a housing. Each semiconductor chip is arranged on a lower conductive plate, and is electrically bonded to the lower conductive plate and an upper conductive plate, each of which constitute an element of the housing. A contact bolt is arranged between the semiconductor chip and the upper conductive plate, which establishes electrical contact between the semiconductor chip and the upper conductive plate.

In normal duty, energy flowing in the electrical device is divided between the parallel-connected semiconductor chips. The heat thus produced can be adequately evacuated by means of a cooling system. In the event of a fault, a short-circuit can occur in one of the semiconductor chips, such that the electrical resistance in the affected semiconductor chip is significantly lower than the electrical resistance in the remaining semiconductor chips. In consequence, the entire, or virtually the entire current in the device will flow, under certain circumstances, through the defective semiconductor chip. This high current concentration on the relatively small cross-sectional area of the defective semiconductor chip results in excessively high temperatures. These can result in the damage or destruction of the semiconductor chip or of the entire housing, thus resulting in the failure of the entire electrical device.

Where the safety arrangement according to the invention is employed in an electrical device of this type, the electrical series circuit formed by one contact piece, the metal foam body, the semiconductor component and the other contact piece is preferably separable, whereby an electrically-isolating gap is formed between the semiconductor component and one of the contact pieces upon the melting of the metal foam body. By this arrangement, the short-circuit current which would otherwise flow through the defective semiconductor component can be interrupted, and can be distributed between other current paths, for example in further and operational semiconductor components, such that the functionality of the electrical device, by means of appropriate design, can be maintained in the remaining current paths. Accordingly, the fault on one of the semiconductor components does not necessarily result in the damage or failure of the electrical device.

Moreover, as a result of its porosity, the metal foam body has controllable elastic properties, in a similar manner to a pressure spring. These properties can advantageously be employed to maintain an optimum compression force on the semiconductor component at all times.

The semiconductor component can, for example, be a diode or a switchable semiconductor, such as a thyristor or an IGBT (insulated gate bipolar transistor). The metal foam body can appropriately melt within a time interval which corresponds to the switching time of the switchable semiconductor.

The electrical device also comprises a housing, wherein the contact pieces each form one part of the housing respectively. In this way, a plurality of electrical devices can be simply and cost-effectively electrically interconnected, for example by stacking. The number of separate outgoing connectors or terminals from the housing can be advantageously reduced. In this case, the contact pieces serve as electrical contacts for other electrical devices.

Preferably, the electrical device incorporates a plurality of semiconductor components, wherein the semiconductor components are arranged in parallel between the contact pieces, and a series circuit is formed by the association of a metal foam body with each semiconductor component, wherein each series circuit is separable by the melting of its associated metal foam body.

It is particularly advantageous if the metal foam body is configured such that the melting thereof is caused in the event of a short-circuit on the semiconductor component. By the appropriate selection of the metal foam, the melting of the metal foam body can be achieved in response to a current on the respective series circuit which exceeds a predefined threshold value. A protective device is thus provided in each series circuit which will disconnect the series circuit in response to a specific short-circuit current. This is specifically possible if the form and composition of the metal foam body are adapted in accordance with the relationship between the current in the respective series circuit and the temperature generated therein, which is associated with the conducting resistance of the series circuit.

According to a further form of embodiment of the invention, the electrical device is configured as a pressure assembly. This means that the contact pieces, the metal foam body and the semiconductor components are mechanically compressed together.

The invention also relates to a method for the interruption of an electric current by an electrical safety arrangement with two contact pieces, arranged one on top of the other.

A further object of the invention is the proposal of a simple and cost effective method of this type.

This object is fulfilled by a method, wherein a metal foam arranged between the contact pieces is caused to melt by a current value which exceeds a predefined current threshold value.

Advantageously, the metal foam is caused to melt by the current which flows via the contact pieces. However, it is also conceivable that the melting of the metal foam is proceeds by a different action, in the event of the fulfilment of a predefined condition, for example the overshoot/undershoot of a predefined threshold value for an appropriate measured variable, determined by means of a measuring device.

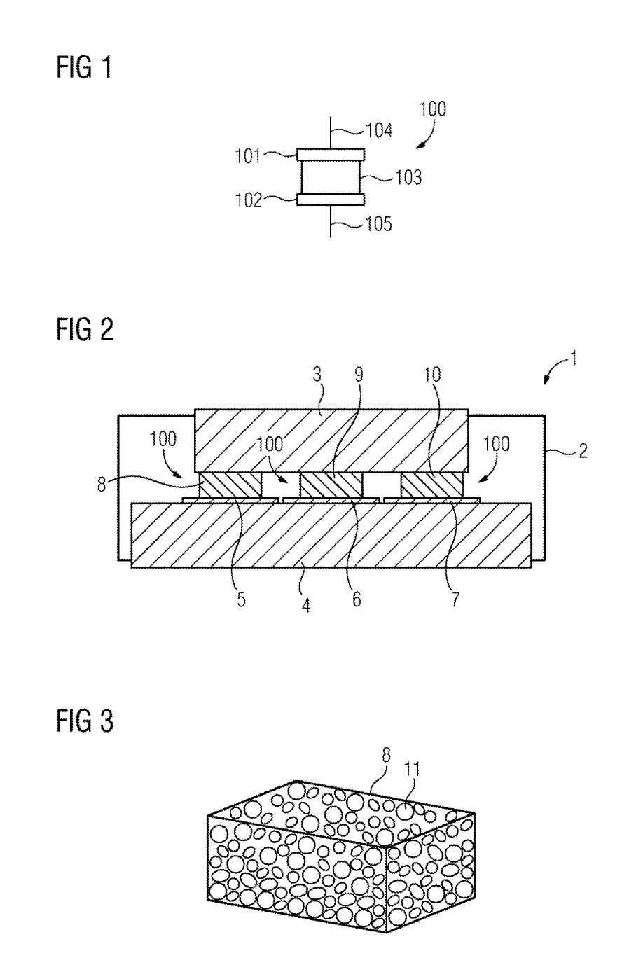

The invention is described in greater detail hereinafter, with reference to FIGS. 1-4.

FIG. 1 shows a schematic representation of an exemplary embodiment of a safety arrangement according to the invention.

FIG. 2 shows a schematic representation of an exemplary embodiment of a safety arrangement according to the invention in an electrical device.

FIG. 3 shows a schematic representation of a metal foam body of the safety arrangement from FIG. 2.

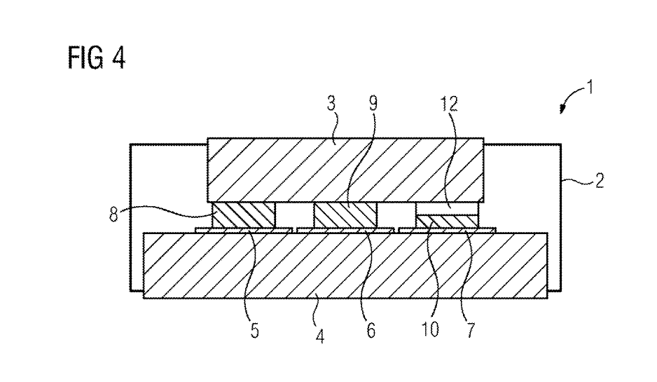

FIG. 4 shows a further schematic representation of the electrical device from FIG. 2.

Specifically, FIG. 1 shows a sketch of an exemplary form of embodiment of the safety arrangement 100 according to the invention. The safety arrangement 100 comprises a first contact piece 101 and a second contact piece 102, which are arranged one on top of the other. A metal foam 103 is arranged between the contact pieces 101, 102. The safety arrangement is a constituent element of a power circuit indicated by the two conductors 104, 105. The power circuit can be, for example, an electrical component.

During the normal duty of the safety arrangement 100, current flows via the conductor 104, the first contact piece 101, the metal foam 103, the second contact piece 102 and the conductor 105. In the event of a short-circuit on the safety arrangement 100, the short-circuit current specifically initiates a strong heat-up of the two contact pieces 101, 102 and the metal foam 103. If a specific short-circuit current value is exceeded, and the resistance of the safety arrangement 100 is also such that the corresponding temperature value is achieved, the metal foam 103 will melt, thereby reducing its volume. As a result, an isolating gap is formed between the two contact pieces 101, 102. The series circuit formed by the contact pieces 101, 102 and the metal foam is thus separated.

The flow of current in the safety arrangement 100 is interrupted.

According to one variant of the invention, the molten metal foam 103 is evacuated from the space between the contact pieces 101, 102 (or flows independently out of said space), thus forming the aforementioned isolating gap.

FIG. 2 shows a cross-section of one form of embodiment of an electric safety arrangement 100 according to the invention, in a device 1. In the exemplary embodiment represented in FIG. 2, the electrical device 1 is configured as a semiconductor module. The semiconductor module 1 has a housing 2, wherein an upper conductive plate constitutes a part of the housing 2. A lower conductive plate 4 also constitutes a part of the housing 2, namely, the base panel of the housing 2. The upper conductive plate 3 and the lower conductive plate 4 form the two contact pieces of the safety arrangement 100.

In the housing 2, the semiconductor components 5, 6 and 7, configured as semiconductor chips, are arranged in parallel adjacently to each other. A metal foam body 8 is arranged between the lower conductive plate 4 or semiconductor chip 5 and the upper conductive plate 3. The upper conductive plate 3, the metal foam body 8, the semiconductor chip 5 and the lower conductive plate 4 form an electrical series circuit. Correspondingly, the further semiconductor chips 6 and 7, with their respective associated metal foam bodies 9 or 10 form two further series circuits. In a normal state of duty, as represented in FIG. 2, current flows through the semiconductor module 1, in which it is divided between three series circuits. In this connection, it should be noted that further semiconductor chips may be provided in the semiconductor module 1, although these are not visible in the cross-sectional representation shown in FIG. 2.

FIG. 3 shows a schematic representation of the metal foam body 8 in the exemplary embodiment of the device according to the invention shown in FIG. 2. The metal foam bodies 9 and 10 from FIG. 2 are of equivalent design to the metal foam body 8. In the exemplary embodiment represented in FIG. 3, the metal foam body 8 is configured with a quadrilateral design. Depending upon the application or the semiconductor geometry, other shapes for the metal foam body, for example cylindrical, disk or spherical shapes, are also conceivable. The metal foam body is comprised of a metal foam. The metal foam is produced by the foaming of a metal powder, using an appropriate propellant. As a result, the metal foam body 8 specifically incorporates pores 11. The size and number of pores 11 dictate the elastic behavior of the metal foam body. The electrical properties of the metal foam body 8 are also influenced by the number and size of the pores 11, and by the shape of the metal foam body 8.

FIG. 4 shows the semiconductor module 1 from FIG. 2, in which the metal foam body 10 is in a molten state. Identical and equivalent components in FIGS. 2 to 4 are identified by the same reference numbers. In the exemplary embodiment represented in FIG. 4, a defect in the semiconductor chip 7 is assumed, whereby the fault sequence proceeds correspondingly in the event of defects on the remaining semiconductor chips 8 or 9. In the event of a defect of this type, a short-circuit is formed in the current path through the semiconductor chip 7. The resulting high temperatures result in the melting of the metal foam body 10. The volume of the metal foam body 10 is reduced accordingly. The molten metal of the metal foam body 10 forms a drop-shaped solid, the weight of which causes it to descend by gravity, i.e. in the direction of the semiconductor chip 7. An electrically isolating gap 12 is thus formed between the semiconductor chip 7 and the upper conductive plate 3. The series circuit formed by the upper conductive plate 3, the metal foam body 10, the semiconductor chip 7 and the lower conductive plate 4 is separated accordingly. The current flux in the semiconductor chip 7 is interrupted. In this case, the current flowing in the semiconductor module 1 is divided between the two remaining current paths which, in this case, are provided by the respective series circuits formed with the semiconductor chip 5 and the semiconductor chip 6. The functionality of the entire semiconductor module 1 can thus be maintained, even in the event of a short-circuit on the semiconductor module 1.

### LIST OF REFERENCE NUMBERS

1 Semiconductor module
2 Housing
3 Upper conductive plate
4 Lower conductive plate
5, 6, 7 Semiconductor chips
8, 9, 10 Metal foam bodies
11 Pores
12 Gap
100 Safety arrangement
101, 102 Contact piece
103 Metal foam
104, 105 Conductor

1-11. (canceled)

12. An electrical fuse configuration, comprising:
two contact pieces disposed on top of one another; and
a metal foam disposed between said contact pieces.

13. The electrical fuse configuration according to claim 12, wherein said metal foam forms a metal foam body being dimensioned to effect electrical isolation between said contact pieces upon melting of said metal foam.

14. The electrical fuse configuration according to claim 13, wherein said metal foam body is a constituent part of one of said contact pieces.

15. The electrical fuse configuration according to claim 13, wherein said metal foam body is configured to melt upon a passage through the fuse configuration of a current exceeding a predefined threshold current value.

16. An electrical device, comprising:
an electrical fuse configuration including:
two contact pieces disposed on top of one another;
at least one semiconductor component disposed between said contact pieces; and
at least one metal foam body each being associated with a respective semiconductor component to form an electrical series circuit;
said at least one metal foam body being dimensioned to effect electrical isolation between said contact pieces and to open said series circuit upon melting of said metal foam body.

17. The electrical device according to claim 16, which further comprises a housing, said contact pieces each forming a respective part of said housing.

18. The electrical device according to claim 16, wherein:
said at least one semiconductor component includes a plurality of semiconductor components disposed in parallel between said contact pieces;
said at least one metal foam body includes a plurality of metal foam bodies each forming a series circuit with a respective one of said semiconductor components; and
each respective series circuit is opened by the melting of said metal foam body of said series circuit.

19. The electrical device according to claim 18, wherein each respective metal foam body is configured to melt upon a short-circuit in said semiconductor component associated with said respective metal foam body in a respective series circuit.

20. The electrical device according to claim 18, wherein said contact pieces, said metal foam bodies and said semiconductor components are mechanically compressed in a pressure assembly.

21. A method for interrupting an electric current in an electrical fuse configuration, the method comprising the following steps:
placing two contact pieces of the electrical fuse configuration on top of one another;
placing a metal foam between the contact pieces; and
melting the metal foam if a current value in the electrical fuse configuration exceeds a predefined threshold current value.

22. The method according to claim 21, which further comprises melting the metal foam due to a passage of current through the contact pieces.
